(19) United States
(12) Patent Application Publication
(10) Pub. No.: US 2014/0137899 A1
(43) Pub. Date: May 22, 2014

(54) PROCESS FOR REMOVING SUBSTANCES FROM SUBSTRATES

(71) Applicant: DYNALOY, LLC, Kingsport, TN (US)

(72) Inventors: Richard Dalton Peters, Kingsport, TN (US); Travis Acra, Ingalls, IN (US); Spencer Erich Hochstetler, Kingsport, TN (US)

(73) Assignee: DYNALOY, LLC, Kingsport, TN (US)

(21) Appl. No.: 13/834,752

(22) Filed: Mar. 15, 2013

Related U.S. Application Data
(63) Continuation-in-part of application No. 13/682,974, filed on Nov. 21, 2012.

(51) Int. Cl. B08B 3/10

(52) U.S. Cl. CPC B08B 3/10
USPC 134/26

(57) ABSTRACT

Processes are described to remove substances from substrates. In an embodiment, a process may include providing a substrate including a first side and a second side with a substance being disposed on at least a portion of the first side of the substrate. The process may also include contacting the substrate with a solution such that the first side of the substrate is coated with the solution, at least a portion of the second side is free of the solution and at least a portion of the substance is released from the first side of the substrate. Additionally, the process may include rinsing the substrate to remove at least a portion of the substance released from the first side of the substrate.

### CROSS-REFERENCE TO RELATED APPLICATION

The present disclosure claims priority to and is a continuation-in-part of U.S. patent application Ser. No. 13/682,974, filed on Nov. 21, 2012, which is incorporated herein by reference.

### STATEMENT OF JOINT DEVELOPMENT

Embodiments of the invention were made pursuant to a joint development agreement between Eastman Chemical Co. and EV Group. The aforementioned joint development agreement is in effect on or before the date the embodiments of the invention were made, and the embodiments of the invention were made as a result of activities undertaken within the scope of the joint development agreement.

### BACKGROUND

Various substances, such as polymers, may be used in the manufacture of electronic devices, such as computer chips, memory devices, light emitting diodes (LEDs), and the like. In some cases, these substances may be used to form features on surfaces of substrates (e.g., semiconductor device substrates) included in electronic devices. In processing the substrates, these substances may be removed from the surfaces of the substrates. In one example, a layer of a substance may be disposed on at least a portion surface of a substrate and at least a portion of the layer may be removed during subsequent processing of the substrates. In another example, the substance may be a residue produced when a particular process is performed on the substrate. In any case, the effectiveness of the removal of the substances from the substrates can affect the quality of the operation of the semiconductor devices.

In an illustrative situation, photoresists and organic-based dielectrics may be used in the manufacture of semiconductor devices included in electronic devices. Photoresists, for example, may be used throughout semiconductor device fabrication in photolithographic operations. A photoresist may be exposed to actinic radiation through a photomask. For example, a polymeric photoresist can be applied to a substrate as a mask to define the placement of solder onto the substrate. After solder is deposited onto the substrate, the photoresist must be removed before the next step in the process can occur. In another example, a polymeric photoresist can be applied to a substrate as an etch mask used to define structures on the substrate that are created in an etch process. After the etch process, there is typically a polymeric residue remaining on the substrate that must be removed before the next step in the process can occur.

In some cases, a positive photoresist may be used. Exposure of the positive photoresist to actinic radiation may cause a chemical reaction resulting in a solubility increase in aqueous alkali that allows the positive photoresist to be dissolved and rinsed away with developer. In other cases, a negative photoresist may be used. When the negative photoresist is exposed to actinic radiation, cross-linking of the polymer may occur in the exposed regions while leaving unexposed regions unchanged. The unexposed regions may be subject to dissolution and rinsing by a suitable developer chemistry. Following development, a resist mask may be left behind. The design and geometry of the resist mask may depend upon the positive or negative tone of the resist; positive tone resist may match the design of the photomask, while a negative tone resist may provide a pattern that is opposite the photomask design.

Photoresists are used extensively in the packaging of microelectronic devices. In wafer level packaging, solder is applied directly to wafers that have completed the fabrication of the microelectronic devices but have not been diced into individual chips. A photoresist is used as the mask to define the placement of the solder on the wafers. After solder is deposited onto the wafer, the photoresist must be removed before the next step in the packaging process can occur. Typically in wafer level packaging, the photoresist is very thick, greater than 50 micrometers and sometimes as thick as 120 micrometers. The photoresist can be positive or negative, and can be applied either as a liquid or a dry film. In wafer level packaging, the use of thick dry film negative photoresist is common.

Due to the thickness and cross-linked nature of thick dry film negative photoresist, the removal of this material after solder deposition can be difficult. The typical process for removing thick dry film negative photoresist in wafer level packaging applications is immersion of the wafer in formulated organic solvent-based mixtures for extended periods of time, often longer than 1 hr. Typically, 25 wafers are immersed in a tank containing the formulated solvent-based mixture for a sufficient time to completely remove the photoresist film. After a sufficient period of time, the wafers are transferred to additional tanks for rinsing, where the rinsing media may include water or isopropanol. Additional wafers are then processed in the same tank reusing the same formulated mixture, and the process is repeated for as long as the formulated mixture is capable of sufficiently removing the photoresist completely from the wafer.

Additional wafers are then processed in the same tank reusing the same formulated mixture, and the process is repeated for as long as the formulated mixture is capable of sufficiently removing the photoresist completely from the wafer. As wafers are processed in the tank, the formulated mixture is constantly changing due to the incorporation of photoresist as it is removed from the wafers and due to degradation of components in the mixture. Once the mixture is no longer capable of sufficiently removing resist from wafers, the tank is drained and cleaned, and fresh formulation is added to the tank.

Disadvantages of immersion-based cleaning of thick dry film negative photoresist include long processing times, large volumes of chemicals required per wafer to sufficiently remove the photoresist, and variability in cleaning performance due to the constantly changing composition of the mixture.

Furthermore, in some cases, removal of photoresist or residue can also be performed using a single wafer spray process. In such a process, a single wafer is sprayed with a heated chemical formulation for a sufficient time until the resist or residue has been completely removed from the wafer. Optionally, the chemical formulation is recycled and reused multiple times to process multiple wafers. The formulation is heated prior to spraying onto the wafer, and is continuously maintained at the processing temperature inside the equipment.

In other cases, removal of photoresist or residue can occur in a combination immersion and spray system which occurs in a 2-step process. In such a process, individual wafers are immersed in the heated immersion tank at regular intervals. The interval is defined by the time needed to process the wafer through the second spray step. Many configurations exist, but at least one spray station must be available when the maximum immersion time is reached for each wafer. The wafers remain in the immersion tank for a period of time to remove at least the majority of the photoresist. They are subsequently moved to a spray station where optionally, heated chemical formulation may be sprayed on it to complete resist or residue removal before spraying a rinse solution to remove the strip chemical.

Conventional single wafer spray processes for removal of resist or residue have several limitations. For example, the formulation used to remove the substances from the wafers is constantly maintained at the process temperature, which can lead to degradation of the chemical composition and reduce the usable lifetime of the formulation. Recycling of the formulation can lead to cross-contamination issues and inconsistent cleaning performance due to variable composition of the formulation. In addition, the equipment is typically configured to allow only a single formulation to be used at a given time, which can limit flexibility to process different wafer types.

### SUMMARY

In one embodiment, the disclosure is directed to a process that may include providing a substrate including a first side and a second side substantially parallel to the first side. A substance may be disposed on a least a portion of the first side of the substrate. The process may also include contacting the substance with a solution such that the first side of the substrate is coated with the solution to a thickness and at least a portion of the second side is free from the solution. The solution may include an organic base. The solution can also include less than 1000 parts per million (ppm) of a sulfonated polymer, a sulfonated monomer, or both. Further, the process can include rinsing the first side of the substrate with a volume of a rinsing agent sufficient to remove a volume of the solution on the substrate and the at least a portion of the substance released from the first side of the substrate.

In another embodiment, a process may include providing a substrate including a first side and a second side substantially parallel to the first side. A substance may be disposed on at least a portion of the first side of the substrate to a first thickness. The process may also include contacting the substance with a solution such that the first side of the substrate is coated with the solution to a second thickness, at least a portion of the second side of the substrate is free from the solution and at least a portion of the substance is released from the first side of the substrate. The second thickness can be greater than 1 mm and a ratio of the second thickness to the first thickness may be greater than 6:1. In addition, the process may include rinsing the first side of the substrate with a volume of a rinsing agent sufficient to remove a volume of the solution on the first side of the substrate and the at least a portion of the substance released from the first side of the substrate.

In an additional embodiment, a process may include placing a substrate in an apparatus including a process bowl. The substrate can include a first side and a second side substantially parallel to the first side and a substance disposed on at least a portion of the first side of the substrate. The process also includes contacting the substrate with a solution by dispensing the solution into the process bowl after placing the substrate in the apparatus such that the first side of the substrate is coated with the solution and at least a portion of the second side of the substrate is free from the solution. Additionally, the process includes heating the solution, the substrate, or both after dispensing the solution into the process bowl for a duration in a range of 20 seconds to 20 minutes such that at least a portion of the substance is released from the first side of the substrate. Further, the process includes rinsing the first side of the substrate with a volume of a rinsing agent sufficient to remove a volume of the solution on the first side of the substrate and the at least a portion of the substance released from the first side of the substrate.

In a further embodiment, the process includes providing a substrate including a first side and a second side substantially parallel to the first side, where a substance is disposed on at least a portion of the first side of the substrate. The process can also include contacting the substance with a solution such that the first side of the substrate is coated with the solution to a thickness and at least a portion of the second side of the substrate is free from the solution. In an embodiment, the solution includes a polar solvent. The solution can also include less than 1000 parts per million (ppm) of a sulfonated polymer, a sulfonated monomer, or both. In addition, the process can include heating the solution, the substrate, or both after contacting the substrate with the solution to a temperature and for a time sufficient to release at least a portion of the substance from the first side of the substrate. Further, the process can include rinsing the first side of the substrate with a volume of a rinsing agent sufficient to remove the solution and the at least a portion of the substance released from the first side of the substrate.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a flow diagram of an embodiment of an example process to remove substances from substrates.

FIG. 2 illustrates a cross-sectional view of an embodiment of an apparatus that holds a substrate that includes a substance to be removed.

### DETAILED DESCRIPTION

This disclosure describes embodiments of processes to remove substances from substrates. In an embodiment, a substance may be removed from a substrate by contacting the substance with a solution, such as a stripping solution. When the substance is in contact with the stripping solution, the substance may be released from a surface of the substrate. In a particular embodiment, the substrate may be contacted by the stripping solution such that a first side of the substrate is coated with the stripping solution, while at least a portion of the second side is free from the solution. Thus, the substance may be removed from the substrate without immersion of the substrate in the stripping solution. Accordingly, the long processing times and variability in performance associated with immersion-based techniques for the removal of substances, such as photoresist, are avoided by using processes described according to embodiments herein. Further, the volume of stripping solution used to remove the substance from the substrate is reduced in comparison to the volumes of solutions used to remove substances from wafers in immersion-based processes, which reduces the cost of removing substances from substrates.

In various embodiments, the stripping solution may coat the side of the substrate that includes the substance to a particular thickness, such as greater than 1 mm. In other embodiments, the stripping solution may coat the side of the substrate that includes the substance to a thickness of 1 mm or less. Additionally, the stripping solution may coat the side of the substrate that includes substance to a thickness such that a ratio of a thickness of the stripping solution to a thickness of the substance on at least a portion of the substrate is greater than 6:1. In some cases, the release of the substance from the surface of the substrate may be facilitated by heating the substrate, the solution, or both. In other situations, the substance may be released from the substrate without heating the substrate and/or the solution. In addition, the substance may be removed from the substrate with minimal agitation or no agitation.

Embodiments of processes described herein may be utilized to remove substances from substrates, such as microelectronic wafers, flat panel displays, LEDs, and so forth. In particular embodiments, the techniques described herein can be used to remove photoresist from electronic device substrates. In some cases, the photoresist may be removed in conjunction with wafer level packaging operations.

The term “coating” is defined as a method for applying a film to a substrate such as spray coating, puddle coating, or slit coating. The term “release” or “releasing” relates to removal of the substance form the substrate and is defined to include dissolution of the substance. The term “residue” includes the photoresist residues before etching and etch residues that include the photoresist byproducts of the etching process, deposits on the solder caps, and other organometallic residues unless specific reference is made to the type of residue. The terms “stripping”, “removing”, and “cleaning” are used interchangeably throughout this specification. Likewise, the terms “stripping composition”, “stripping solution”, and “cleaning composition” are used interchangeably. The indefinite articles “a” and “an” are intended to include both the singular and the plural. All ranges are inclusive and combinable in any order except where it is clear that such numerical ranges are constrained to add up to 100%, and each range includes all the integers within the range. The terms “weight percent” or “wt %” mean weight percent based on the total weight of the composition, unless otherwise indicated.

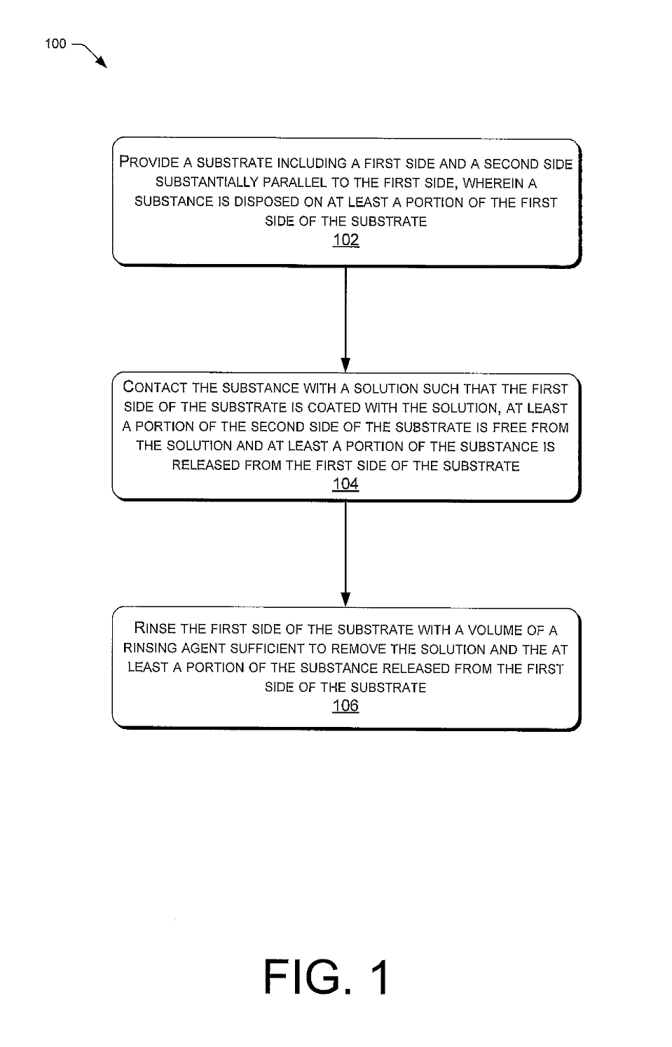

FIG. 1 is a flow diagram of an embodiment of an example process 100 to remove substances from substrates. At 102, the process 100 includes providing a substrate including a first side and a second side substantially parallel to the first side. The substrate may include an inorganic substrate, such as a silicon-containing substrate. For example, in one embodiment, the substrate may include silicon dioxide. In some cases, the silicon-containing substrate may be doped with one or more materials, such as B, Ga, As, P, or combinations thereof. The substrate may also include one or more metals. In other embodiments, the substrate may include organic materials, such as one or more polymeric materials. In one example, the substrate may include a polyimide.

In an embodiment, surfaces of the substrate may be circular in shape, while in other embodiments, surfaces of the substrate may be planar in shape, such as rectangular or square-shaped. Additionally, the substrate may have one or more dimensions defining a surface area of the substrate, such as radius, diameter, length, width, or combinations thereof. The substrate may also have a thickness. In a particular embodiment, the thickness of the substrate includes the thickness of one or more layers of the substrate.

In various embodiments, a substance may be disposed on the substrate. In some cases, the substance may be disposed on one side of the substrate. In one example, the substance may be disposed as a layer covering substantially all of a particular side of the substrate. In another example, the substance may be disposed on portions of the particular side of the substrate, while other portions of the particular side of the substrate are free from the substance. In an embodiment, the substance may be disposed on the particular side of the substrate according to a pattern.

In addition, in some instances, the thickness of the substance disposed on the substrate may be substantially uniform, while in other situations, the thickness of the substance disposed on the substrate varies. In an embodiment, the thickness of the substance disposed on the substrate may be no greater than 400 micrometers, no greater than 250 micrometers, no greater than 100 micrometers, no greater than 50 micrometers, no greater than 10 micrometers, or no greater than 2 micrometers. In an illustrative embodiment, the thickness of the substance on the substrate may be included in a range of 0.1 micrometers to 500 micrometers. In another illustrative embodiment, the thickness of the substance on the substrate may be included in a range of 40 micrometers to 150 micrometers. In a further illustrative embodiment, the thickness of the substance disposed in the substrate may be included in a range of 0.5 micrometers to 5 micrometers.

In a particular embodiment, photoresist may be disposed on a side of the substrate. In some cases, the photoresist may be a negative photoresist, and in other instances, the photoresist may be a positive photoresist. In an embodiment, the photoresist disposed on a side of the substrate may have been exposed to actinic radiation, such as ultraviolet light. A thickness of the photoresist disposed on a side of the substrate can be in a range of 0.3 micrometers to about 150. In some cases, the photoresist may be applied to the substrate in conjunction with forming particular features on the substrate. In some instances, photoresist may remain on portions of the substrate after the formation of the particular features of the substrate. Additionally, in some situations, photoresist residue can be disposed in features formed on the substrate, such as vias and/or trenches, after an etch process to remove the photoresist from the substrate subsequent to the formation of the features. In these situations, the thickness of the photoresist residue may be no greater than 5 microns, no greater than 2 microns, or no greater than 1 micron. In various embodiments, the thickness of the photoresist residue can be even less, such as on the order of tens of nanometers or on the order of hundreds of nanometers.

In one illustrative example, the features formed on the substrate may include a number of vias. In another illustrative example, the features formed on the substrate may be related to a package substrate for a computer chip. To illustrate, the substrate may include metal pillars or balls that are used to electrically connect portions of a package substrate with portions of the computer chip and/or connect portions of the package substrate with a circuit board that the computer chip is attached to. The metal pillars may include Cu, Al, Au, or solder. In some scenarios, the solder may include an alloy of Pb and Sn, an alloy of Sn and Ag, or both. In a non-limiting illustrative embodiment, the metal pillars may include Cu with a solder cap.

In another particular embodiment, the substance formed on the substrate may include residue from one or more processes that have been applied to the substrate. For example, a plasma etch process may have been used to form features on the substrate, and the plasma etch process may have formed residue on a side of the substrate. In some situations, the residue may include one or more polymers, one or more metals (e.g., copper, titanium), one or more silicon-containing materials, or combinations thereof. In these cases, the thickness of the residue on the substrate may vary across the surface of the substrate. Additionally, in particular instances, the thickness of the residue on the substrate may be no greater than 10 micrometers, no greater than 5 micrometers, no greater than 2 micrometers, or no greater than 1 micrometer. In some cases, the thickness of the residue on the substrate may be even less, such as on the order of tens of nanometers or hundreds of nanometers.

Furthermore, in an embodiment, the substrate may be provided to an apparatus where one or more operations can be performed with respect to the substrate. In a particular embodiment, the apparatus may include a process bowl (also referred to herein as a “chuck”) configured to hold the substrate. The substrate may be contacted by a number of substances while being held by the process bowl. In some cases, the process bowl may be configured to hold a single substrate, while in other situations the process bowl may be configured to hold multiple substrates.

At 104, the process 100 includes contacting the substrate with a solution such that a first side of the substrate is coated with the solution and at least a portion of a second side of the substrate is free from the solution. In some cases, at least a portion of the second side of the substrate may be exposed to air, while in other instances at least a portion of the second side of the substrate may contact an apparatus holding the substrate. In additional situations, at least a portion of the second side of the substrate may be in contact with an insulating layer. In an embodiment, the insulating layer may include a polymer. For example, the insulating layer may include a polyether ether ketone (PEEK). In another example, the insulating layer may include a polytetrafluoroethylene (PTFE).

In an embodiment, the substrate may be contacted with the solution such that at least a portion of a substance disposed on a side of the substrate is released. In some cases, the substrate may be contacted with a volume of the solution that is fresh, has not been used previously, and does not contain any recycled components. In other situations, the substrate may be contacted with a volume of the solution that has been previously used to release a substance from a substrate.

In one embodiment, the solution may include solvent-based compositions that dissolve the targeted substance (e.g., photoresist) or cause the targeted substance to be released from the substrate. In some embodiments, the solution may include a hydrotrope. Non-limiting examples of the solution may include, but are not limited to, compositions comprising a polar solvent, an organic base, or a combination thereof. In an illustrative embodiment, the polar solvent may include a polar aprotic solvent, such as a dimethyl sulfoxide, a dimethylformamide, a dimethylacetamide, a 1-formylpiperidine, a dimethylsulfone, a n-methylpyrrolidone (NMP), a N-cyclohexyl-2-pyrrolidone, or mixtures thereof. In various embodiments, the solution may include at least 10 wt % polar solvent of a total weight of the solution, at least 18 wt % polar solvent of a total weight of the solution, at least 30 wt % polar solvent of a total weight of the solution, at least 50 wt % polar solvent of a total weight of the solution, or at least 65 wt % polar solvent of a total weight of the solution. In other embodiments, the solution may include no greater than 90 wt % polar solvent of a total weight of the solution, no greater than 85 wt % polar solvent of a total weight of the solution, no greater than 80 wt % polar solvent of a total weight of the solution, or no greater than 75 wt % polar solvent of a total weight of the solution. In an illustrative embodiment, an amount of polar solvent included in the solution may be in a range of 10 wt % to 99 wt % of a total weight of the solution. In another illustrative embodiment, an amount of polar solvent included in the solution may be in a range of 25 wt % to 80 wt % of a total weight of the solution. In an additional illustrative embodiment, an amount of polar solvent included in the solution may be in a range of 59 wt % to 72 wt %. Further, substantially all of the solution can include the polar solvent in a further illustrative embodiment.

In another illustrative embodiment, the organic base can include an alkylammonium hydroxide, an alkanolamine, an amine, or a combination thereof. In a particular illustrative embodiment, the alkanolamine may include an ethanolamine, a dimethylaminoethanol, an aminoethylethanolamine, a N-methylethanolamine, a N-ethylethanolamine, a N-propylethanolamine, a N-butylethanolamine, a diethanolamine, a triethanolamine, a N-methyldiethanolamine, a N-ethyldiethanolamine, an isopropanolamine, a diisopropanolamine, a triisopropanolamine, a N-methylisopropanolamine, a N-ethylisopropanolamine, a N-propylisopropanolamine, a 2-aminopropane-1-ol, a N-methyl-2-aminopropane-1-ol, a N-ethyl-2-aminopropane-1-ol, a 1-aminopropane-3-ol, a N-methyl-1-aminopropane-3-ol, a N-ethyl-1-aminopropane-3-ol, a 1-aminobutane-2-ol, a N-methyl-1-aminobutane-2-ol, a N-ethyl-1-aminobutane-2-ol, a 2-aminobutane-1-ol, a N-methyl-2-aminobutane-1-ol, a N-ethyl-2-aminobutane-1-ol, a 3-aminobutane-1-ol, a N-methyl-3-aminobutane-1-ol, a N-ethyl-3-aminobutane-1-ol, a 1-aminobutane-4-ol, a N-methyl-1-aminobutane-4-ol, a N-ethyl-1-aminobutane-4-ol, a 1-amino-2-methylpropane-2-ol, a 2-amino-2-methylpropane-1-ol, a 1-aminopentane-4-ol, 2-amino-4-methylpentane-1-ol, a 2-aminohexane-1-ol, a 3-aminoheptane-4-ol, a 1-aminooctane-2-ol, a 5-aminooctane-4-ol, a 1-aminopropane-2,3-diol, a 2-aminopropane-1,3-diol, tris(oxymethyl)aminomethane, a 1,2-diaminopropane-3-ol, a 1,3-diaminopropane-2-ol, and a 2-(2-aminoethoxy)ethanol, or mixtures thereof. In another particular illustrative embodiment, the amine may include diethylenetriamine, triethylenetetramine, tetraethylenepentamine, dimethylbenzylamine, malonamide, or mixtures thereof. In some embodiments, the solution may include at least 0.5 wt % organic base of a total weight of the solution, at least 2 wt % organic base of a total weight of the solution, at least 10 wt % organic base of a total weight of the solution, at least 25 wt % organic base of a total weight of the solution, or at least 35 wt % organic base of a total weight of the solution. Additionally, the solution may include no greater than 70 wt % organic base of a total weight of the solution, no greater than 60 wt % organic base of a total weight of a solution, no greater than 50 wt % organic base of a total weight of a solution, or no greater than 40 wt % organic base of a total weight of a solution. In an illustrative embodiment, an amount of organic base included in the solution may be in a range of 0.5 wt % to 99 wt % of a total weight of the solution. In another illustrative embodiment, an amount of organic base included in the solution may be in a range of 10 wt % to 75 wt % of a total weight of the solution. In an additional illustrative embodiment, an amount of organic base included in the solution may be in a range of 23 wt % to 40 wt % of a total weight of the solution. In a further illustrative embodiment, substantially all of the solution can include the organic base.

In a further illustrative embodiment, the quarternary ammonium hydroxide may include a tetramethylammonium hydroxide, a tetramethylammonium hydroxide pentahydrate, a tetrabutylammonium hydroxide, a benzyltrimethylammonium hydroxide, a tetrapropylammonium hydroxide, a dimethyldipropylammonium hydroxide, a tetraethyl ammonium hydroxide, a dimethyldiethyl ammonium hydroxide or mixtures thereof. In an illustrative embodiment, an amount of quarternary ammonium hydroxide included in the solution may be in a range of 0.5 wt % to 10 wt % of a total weight of the solution. In another illustrative embodiment, an amount of quarternary ammonium hydroxide included in the solution may be in a range of 2 wt % to 6 wt % of a total weight of the solution. In some situations, the solution may be free of quarternary ammonium hydroxide.

The solution may also include additives, such as metal corrosion inhibitors, surfactants, acids, bases, additional solvents, alcohols, or mixtures thereof. In a particular embodiment, the solution can include an ethylenediaminetetraacetic acid (EDTA), a dihydroxybenzene, a propylene glycol, a 3-methoxy-3-methyl butanol, water, or combinations thereof. In one embodiment, the corrosion inhibitor can include dodecanedioic acid, undecanedioic acid, sebacic acid, or mixtures thereof. In an illustrative embodiment, an amount of additive in the solution may be in a range of 1 ppm to 12 wt % of a total weight of the solution.

Additionally, in some instances, the solution may include an amount of a polymeric material. For example, the solution may include no greater than 10 wt % polymeric material of a total weight of the solution, no greater than 6 wt % polymeric material of a total weight of the solution, or no greater than 2 wt % polymeric material of a total weight of the solution. In another example, the solution may include no greater than 1000 parts per million (ppm) of polymeric material, no greater than 500 ppm polymeric material, or no greater than 100 ppm polymeric material. In other situations, the solution may be free of polymeric material. In an illustrative embodiment, the solution can include 50 ppm polymeric material to 5 wt % polymeric material of a total weight of the solution. In another illustrative embodiment, the solution can include 100 pm to 1000 ppm polymeric material. In one embodiment, the polymeric material can include a sulfonated polymer, a sulfonated monomer, or a combination thereof. In a particular embodiment, the polymeric material can include a sulfopolyester.

In an embodiment, contacting the substrate with the solution can include providing a volume of the solution to a particular side of the substrate that includes a substance, such as photoresist or plasma etch residue. In some cases, providing the volume of the solution to the substrate may include coating the particular side of the substrate with the solution. In various embodiments, the solution can be dispensed into a process bowl that is holding the substrate. According to an embodiment, the substrate may be coated with the solution by spin-coating, spray coating, puddle coating, or slit coating. In a particular embodiment, the substrate may be coated with the solution without agitation.

The volume of the solution may be sufficient to coat at least a portion of a side of the substrate that includes the substance. According to other embodiments, the volume of the solution may be sufficient to coat the entire side of the substrate that includes the substance. In a particular embodiment, the substrate may be coated with at least 10 mL of the solution, at least 40 mL of the solution, at least 100 mL of the solution, at least 150 mL of the solution, at least 175 mL of the solution, at least 190 mL of the solution, or at least 205 mL of the solution. In another particular embodiment, the substrate may be coated with no greater than 400 mL of the solution, no greater than 350 mL of the solution, no greater than 300 mL of the solution, no greater than 250 mL of the solution, no greater than 235 mL of the solution, or no greater than 220 mL of the solution. In an illustrative embodiment, an amount of the solution utilized to coat a 300 mm wafer may be in a range of 50 mL to 300 mL or in a range of 70 mL to 220 mL. In another illustrative embodiment, an amount of the solution utilized to coat a 200 mm wafer may be in a range of 30 mL to 100 mL or in a range of 40 mL to 75 mL. In an additional illustrative embodiment, an amount of the solution utilized to coat a 150 mm wafer may be in a range of 8 mL to 25 mL or in a range of 12 mL to 18 mL.

In some cases, the volume of the solution applied to a side of the substrate may form a coating on the substrate, where the coating has a particular thickness. In one embodiment, the thickness of the coating may be substantially uniform. In a particular embodiment, the thickness of the coating may be at least 0.2 mm, at least 0.5 mm, at least 1 mm, at least 1.5 mm, at least 2 mm, at least 2.5 mm, at least 3 mm, or at least 3.5 mm. In another particular embodiment, the thickness of the coating may be no greater than 5 mm, no greater than 4.5 mm, or no greater than 4 mm. In various embodiments, the thickness of the coating can be greater than 1 mm, while in other embodiments, the thickness of the coating can be less than 1 mm. In an illustrative embodiment, the thickness of the coating may be in a range of 0.4 mm to 8 mm. In another illustrative embodiment, the thickness of the coating may be in a range of 1 mm to 5 mm. In a further illustrative embodiment, the thickness of the coating may be in a range of 1.5 mm to 3 mm.

In addition, a ratio of a thickness of the solution on a side of the substrate to a thickness of the substance on at least a portion of the substrate may be at least 6:1, at least 8:1, at least 12:1, or at least 15:1. Further, a ratio of a thickness of the solution on a side of the substrate to a thickness of the substance on at least a portion of the substrate may be no greater than 35:1, no greater than 30:1, no greater than 25:1, or no greater than 20:1. In an illustrative embodiment, the ratio of the thickness of the solution on a side of the substrate to a thickness of the substance on at least a portion of the substrate may be in a range of 6:1 to 25:1. In situations where the substance to be removed from the substrate is a residue having a thickness of less than 1 micron, the ratio of the thickness of the solution on a side of the substrate to a thickness of the substance on at least a portion of the substrate may be greater than 35:1. For example, in other illustrative embodiments, the ratio of the thickness of the solution on a side of the substrate to a thickness of the substance on at least a portion of the substrate may be at least 50:1, at least 100:1, at least 250:1, at least 750:1, at least 2000:1, at least 5000:1, or at least 10,000:1. Furthermore, in these instances, the ratio of the thickness of the solution on a side of the substrate to a thickness of the substance on at least a portion of the substrate can be included in a range of 6:1 to 25,000:1, 8:1 to 1000:1, 15:1 to 250:1, or 20:1 to 100:1.

In a particular embodiment, the thickness of the coating can be different for different substances depending, at least in part, on the composition of the substances. For example, a first thickness of the coating may be applied when removing a first substance from the substrate, such as a negative photoresist. In another example, a second thickness of the coating may be applied when removing a second substance from the substrate, such as post etch residue. Additionally, the thickness of the coating may depend, at least in part on a thickness of the substance disposed on the substrate.

In an embodiment, contacting the substance on the substrate with the solution may also include heating the solution, the substrate, or both to a temperature that provides for the removal of the substance within a specified period of time. In one embodiment, the solution may be heated by convective heating via placement of a heat source within a particular distance of the surface of the liquid. In one illustrative instance, the heat source does not include a liquid, such as the solution, a rinsing agent, a combination thereof, and the like. In another embodiment, the solution may be heated through irradiation with infrared radiation. In a further embodiment, the solution may be heated by conductive heating either through contacting the backside of the wafer with a heat source or directly contacting the solution with the heat source. In an embodiment, the solution, the substrate, or both may be heated to a target temperature. In an illustrative embodiment, the heat source can have a temperature that is greater than the target temperature. For example, the heat source can have a temperature that is 10° C. to 300° C. greater than the target temperature, 50° C. to 200° C. greater than the target temperature, or 75° C. to 125° C. greater than the target temperature. In a particular illustrative embodiment, the heat source can have a temperature that is at least 50° C. greater than the target temperature, at least 100° C. greater than the target temperature, at least 150° C. greater than the target temperature, or at least 200° C. greater than the target temperature. In this way, heating of the solution can occur more quickly. In some instances, the solution may be heated before contacting the substrate with the solution. In other situations, the solution may be heated after contacting the substrate with the solution. In particular, the solution can be heated after being dispensed into a process bowl holding the substrate. By heating the solution after contacting the substrate with the solution, degradation of the solution can be minimized due to decreased exposure of the solution to elevated temperatures.

In one embodiment, the solution may be heated to a temperature of at least 30° C., at least 40° C., at least 65° C., at least 80° C., at least 90° C., at least 95° C., or at least 100° C. In an additional embodiment, the solution may be heated to a temperature of no greater than 105° C., no greater than 110° C., no greater than 115° C., or no greater than 120° C. In an illustrative embodiment, the solution may have a temperature in a range of 20° C. to 150° C. In another illustrative embodiment, the solution may have a temperature in a range of 75° C. to 125° C. In various embodiments, the solution, the substrate, or both can be heated from a starting temperature to a target temperature. In an embodiment, a difference between the starting temperature and the target temperature can be at least 10° C., at least 20° C., at least 50° C., at least 100° C., or at least 150° C.

In some scenarios, the temperature of the solution may have a temperature variation from the target temperature of no greater than ±5° C., ±3° C., or ±2° C. The target temperature of the solution may be maintained by manipulating a distance between the substrate and/or solution and the heat source. In one embodiment, a heat source at a temperature in a range of about 200° C. to about 300° C. may be placed within a distance of the surface of the solution in a range of about 0.5 mm to about 2.5 mm. In some cases, the heat source can also be moved to a greater distance from the substrate and/or solution in order to maintain the temperature of the substrate and/or solution within a range of specified temperatures. In these situations, the position of the heat source can also be varied within a range of distances to heat the substrate and/or solution to maintain the temperature of the substrate and/or solution within the range of specified temperatures.

In an alternative embodiment, the solution may not be subjected to heating and may be maintained on the substrate at ambient or room temperature. For example, the temperature of the solution may be in a range of about 15° C. to about 30° C. The substrate may be coated with the solution at ambient temperature for a duration sufficient to allow for the dissolution of the substance or the release of the substance from the substrate.

In some cases, the substrate may be contacted with the solution for a duration of at least 20 seconds, at least 2 minutes, at least 3 minutes, at least 4 minutes, or at least 5 minutes. Additionally, the substrate may be contacted with the solution for a duration of no greater than 20 minutes, no greater than 8 minutes, or no greater than 6 minutes. In particular embodiments, the substrate can be contacted with the solution for durations of greater than 20 minutes depending on the composition of the substance to be removed from the substrate. In an illustrative embodiment, the substrate may be contacted with the solution for a duration in a range of about 0.5 minutes to about 9.5 minutes. In another illustrative embodiment, the substrate may be contacted with the solution for a duration in a range of about 2 minutes to 6 minutes.

According to an embodiment, the solution and/or the substrate can be agitated while the solution contacts the substance on the substrate. In various embodiments, the solution, the substrate, or both can be agitated after the solution is dispensed into a process bowl holding the substrate. Agitation can be by any means such as, for example, by mechanical, sonic, or electrical force. In one embodiment, the wafer is mechanically agitated via spinning the wafer. In another embodiment, the wafer can be mechanically agitated by oscillating the wafer back and forth and/or side to side. In a particular embodiment, the agitation technique is not generated by way of spray head or spraying a liquid, such as the solution or rinse media, onto the substrate. Agitation of the substrate and/or solution can provide a more uniform temperature distribution of the solution and can also help to release the substance from the substrate.

Additionally, in an embodiment, after the substrate has been contacted with the solution for a particular duration, the substrate may be agitated via mechanical, sonic, and/or electrical force. In a particular embodiment, the substrate is mechanically agitated by rotating the substrate at a target speed that is sufficient to fling off or otherwise substantially remove the solution and the released and/or dissolved substance. According to some embodiments, the substrate may be rotated at a speed in a range of 50 rpm to 2000 rpm, in a range of 100 rpm to 1000 rpm, or in a range of 150 rpm to 500 rpm. In an illustrative embodiment, the substrate may be accelerated at 200 rpm/sec to achieve the target speed. Furthermore, in various embodiments, the solution can be drained from an apparatus holding the substrate after contacting the substrate with the solution for a particular duration.

At 106, the process 100 may include rinsing the substrate to produce a rinsed substrate. The rinsed substrate may also be substantially free from the substance previously disposed on a side of the substrate. The conditions for rinsing the substrate may be selected to prevent areas of the substrate from becoming dry during the rinsing process.

In one embodiment, the substrate may be rinsed with one or more rinsing agents. As used herein, the term “rinsing agent” includes any solvent that removes the stripping solution, other solution and/or released substance to be stripped. One or more of the rinsing agents or a particular combination of the rinsing agents may have an interfacial energy with the substrate surface that leads to a liquid-surface contact angle that is sufficiently low to prevent de-wetting of the surface of the substrate. In some cases, a surfactant may be added to a particular rinsing agent to reduce the interfacial energy between one or more of the rinsing agents and the substrate.

Examples of rinsing agents include, but are not limited to, water, pH modified water, deionized water, acetone, alcohols, for example, isopropyl alcohol and methanol, Dimethylsulfoxide (DMSO), and N-methylpyrrolidone (NMP). Rinsing agents can also include mixtures including surfactants such as, for example, Glycol Palmitate, Polysorbate 80, Polysorbate 60, Polysorbate 20, Sodium Lauryl Sulfate, Coco Glucoside, Lauryl-7 Sulfate, Sodium Lauryl Glucose Carboxylate, Lauryl Glucoside, Disodium Cocoyl Glutamate, Laureth-7 Citrate, Disodium Cocoamphodiacetate, nonionic Gemini surfactants including, for example, those sold under the tradename ENVIROGEM 360, nonionic fluorosurfactants including, for example, those sold under the tradename Zonyl FSO, ionic fluorinated surfactants including, for example, those sold under the trade name Capstone FS-10, Oxirane polymer surfactants including, for example, those sold under the tradename SURFYNOL 2502, and poloxamine surfactants, including, for example, those sold under the tradename TETRONIC 701, and mixtures thereof. Further, the rinsing agent can be water containing a sulfonated monomer or polymer in an amount ranging from less than 1% to the limit of solubility of the sulfonated monomer or polymer in the water. In one particular illustrative embodiment, a rinsing agent may include the stripping solution.

According to certain embodiments, rinsing the substrate can include a number of rinsing operations. In some cases, the substrate may be rinsed with de-ionized water one or more times. In additional situations, rinsing the substrate may include contacting the substrate with an aqueous base solution, contacting the substrate with an aqueous acid solution, or both. In various embodiments, the substrate, the rinsing agent, or both can be agitated during one or more rinsing operations. In other embodiments, the substrate, the rinsing agent, or both may not be subjected to agitation during one or more rinsing operations.

In an illustrative embodiment, rinsing the substrate may include contacting the substrate with deionized water followed by contacting the substrate with an aqueous basic solution and then subjecting the substrate to an additional rinse with deionized water. The de-ionized water may be applied to the substrate via fan spray nozzles. Additionally, during the deionized water rinses, the substrate may be rotated at a speed of at least 50 rpm, at least 200 rpm, or at least 400 rpm while being contacted with the deionized water. Further, the substrate may be rotated at a speed of no greater than 2000 rpm, no greater than 1500 rpm, no greater than 1000 rpm, or no greater than 500 rpm while being contacted with the deionized water.

In a particular illustrative embodiment, the substrate may be rotated at a speed in a range of about 300 rpm to about 700 rpm while being contacted with the deionized water. Additionally, the substrate may be contacted with deionized water for a duration in a range of about 2 seconds to about 60 seconds. In another embodiment, the substrate may be contacted with deionized water for a duration in a range of about 5 seconds to about 30 seconds.

In particular embodiments, the substrate may be dried after being rinsed. A drying operation may include heat drying, spin drying, and/or gas contact, such as contacting the substrate with an inert gas in a heated and/or pressurized environment (e.g., air knife). In one embodiment, the substrate may be dried by rotating the substrate at a speed in a range of about 500 rpm to about 2500 rpm or in a range of about 1250 rpm to about 1750 rpm. In an additional embodiment, the substrate may be dried by rotating the substrate for a duration in a range of about 5 seconds to about 45 seconds or in a range of about 15 seconds to about 25 seconds.

A drying operation may also include chemical drying via the application of an appropriate drying agent, such as isopropyl alcohol (IPA) or acetone. Chemical and physical drying techniques may be combined as appropriate. In one embodiment, the substrate is dried chemically by the application of IPA or acetone alone. In another embodiment, the substrate is dried chemically, followed by physical drying. In yet another embodiment, the substrate is chemically dried with, for example, IPA or acetone after physical drying. In an embodiment, the substrate may be rotated while being contacted by the IPA. For example, the substrate may be rotated at a speed in a range of about 50 rpm to about 2000 rpm for a duration in a range of about 10 seconds to about 25 seconds while the substrate is contacted with IPA.

According to one embodiment, the substrate may be subjected to multiple cycles of the operations 104 and/or 106 until the desired level of removal of the substance is achieved. Moreover, any of the operations may be deleted during subsequent cycles as needed. According to one embodiment, multiple cycles of the same solution compositions and rinsing agents may be applied. According to another embodiment, multiple cycles may use different solution compositions in one or more cycles and/or different rinsing agents in one or more cycles. In yet another embodiment, the heating profile in different cycles may be changed. When different chemical cycles are used, the apparatus holding the substrate may be cleaned between cycles, such as via rinsing with water. In an embodiment, after performing operations with respect to blocks 104 and/or 106, at least 80% of the surface of the substrate may be free of the substance, at least 84% of the surface of the substrate may be free of the substance, at least about 88% of the surface of the substrate may be free of the substance, or at least about 93% of the surface of the substrate may be free of the substance. In another embodiment, after performing operations with respect to blocks 104 and/or 106, substantially all of the surface of the substrate may be free of the substance, no greater than 99% of the surface of the substrate may be free of the substance, or no greater than 97% of the surface of the substrate may be free of the substance. In an illustrative embodiment, within about 94% of the surface of the substrate to within about 100% of the surface of the substrate may be free of the substance after operations described with respect to blocks 104 and 106.

In an embodiment, a duration of the process 100 to remove the substance from the substrate may be no greater than 3 minutes, no greater than 5 minutes, no greater than 8 minutes, no greater than 12 minutes, or no greater than 30 minutes. In an illustrative embodiment, the duration of the process 100 to remove the substance from the substrate may be in a range of 1 minute to 30 minutes. In another illustrative embodiment, the duration of the process 100 to remove the substance from the substrate may be in a range of 2 minutes to 15 minutes.

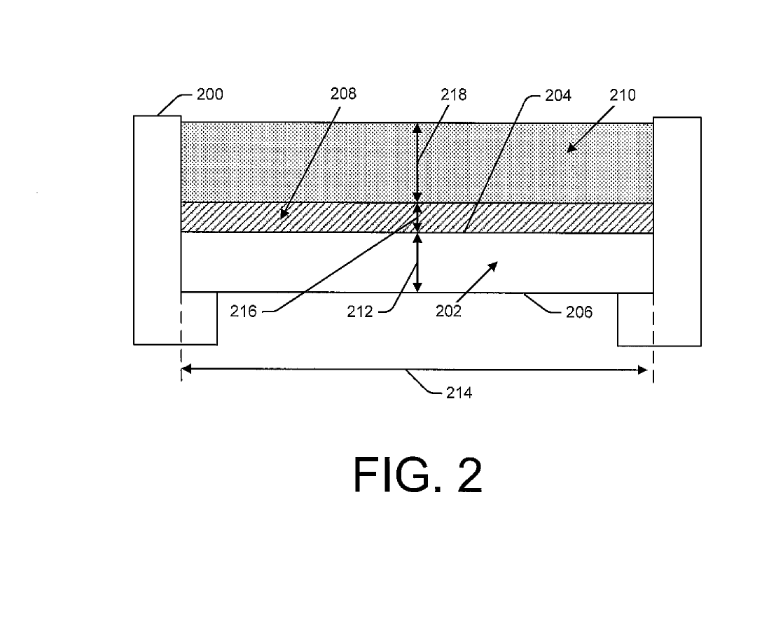

FIG. 2 illustrates a cross-sectional view of an embodiment of an apparatus 200 that holds a substrate 202. In some cases, the substrate 202 may be placed in the apparatus 200 by an operator of the apparatus 200, while in other situations, the substrate 202 may be mechanically placed in the apparatus 200. In a particular embodiment, the apparatus 200 may be configured to rotate the substrate 202. The substrate 202 may include a first side 204 and a second side 206. Although, the substrate 202 is shown in the illustrative example of FIG. 2 as having a single layer, the substrate 202 may include one or more layers. For example, the substrate 202 may include one or more core layers, one or more reinforcing layers, one or more insulating layers, one or more metal layers, or a combination thereof.

In some embodiments, a substance 208 may be disposed on the first side 204 that is to be removed according to embodiments described herein. Although the substance 208 is shown as a layer disposed on the first side 204 in the illustrative embodiment of FIG. 2, in other embodiments, the substance 208 may be disposed on a portion of the first side 204. In particular embodiments, the substance 208 may be disposed on the first side 204 in a pattern. Additionally, although the illustrative embodiment of FIG. 2 includes a single layer of the substance 208, in some situations, the substance 208 may be disposed in multiple layers on the first side 204 of the substrate 202, such as multiple layers of photoresist. In some cases, each of the layers may include different substances to be removed from the substrate 202. Further, although not shown in the illustrative example of FIG. 2, other materials may be disposed on the first side 204. For example, features of circuit patterns, bonding articles (e.g. solder balls), combinations thereof, and the like, may be disposed on the first side 204 in addition to the substance 208. In one embodiment, the second side 206 may be in contact with air. In another embodiment, the second side 206 may be in contact with an insulating polymer, such as polyether ether ketone (PEEK) or polytetrafluoroethylene (PTFE).

In an embodiment, the apparatus 200 may hold a volume of a liquid 210, such that the liquid 210 contacts the substance 208, the first side 204 of the substrate 202, or both. In one embodiment, the liquid 210 may include one or more of the liquids described herein with respect to the process 100, such as a stripping solution, a rinsing agent, or a combination thereof. In an illustrative embodiment, the substrate 202 can be contacted with the liquid 210 by dispensing a volume of the liquid 210 into the apparatus 200. Moreover, when such an apparatus 200 is employed, a portion of the liquid 200 may come in contact with a portion of the second side 206 of the substrate 202, for example, via capillary action. In a particular embodiment at least 50% of a surface of the second side 206 is free of the liquid 210, at least 75% of a surface of the second side 206 is free of the liquid 210, at least 95% of a surface of the second side 206 is free of the liquid 210, or substantially all of a surface of the second side 206 is free of the liquid 210.

The substrate 202 may include a thickness 212 and a width 214. In a particular embodiment, the substrate 202 may include a circular wafer and the width 214 may be a diameter. In one embodiment, the thickness 212 of the substrate 202 is in a range of 250 micrometers to 950 micrometers, in a range of 500 micrometers to 800 micrometers, or in a range of 700 micrometers to 780 micrometers. Additionally, the width 214 of the substrate 202 may be in a range of 50 mm to 450 mm, in a range of 100 mm to 350 mm, or in a range of 200 mm to 300 mm.

The substance 208 can have a thickness 216. In some cases, the thickness 216 may be an average thickness of the substance 208 disposed on the first side 204 of the substrate 202. In other cases, the thickness 216 may represent a maximum thickness of the substance 208 disposed on the first side 204 of the substrate 202. In still additional situations, the thickness 216 may be the thickness of a portion of the substance 208 disposed on the first side 204 of the substrate 202. In an illustrative embodiment, the thickness 216 may be in a range of 0.2 micrometers to 150 micrometers. In another illustrative embodiment, the thickness 216 may be in a range of 40 micrometers to 120 micrometers. In an additional illustrative embodiment, the thickness 216 may be in a range of 50 micrometers to 80 micrometers.

The liquid 210 can have a thickness 218. The thickness 218 may be proportional to the volume of the liquid 210 in the apparatus 200. In one embodiment, the thickness 218 may be in a range of about 0.2 mm to about 7 mm, in a range of about 1 mm to about 4 mm, or in a range of about 2 mm to about 3.5 mm. In some cases, the thickness 218 may be sufficient to remove the substance 208 from the substrate 202.

In particular embodiments, a volume of the liquid 210 placed in the apparatus 200 may produce a specified ratio between the thickness 218 of the liquid 210 and the thickness 216 of the substance 208. For example, a ratio of the thickness 218 to the thickness 216 may be in a range of 6:1 to 25:1. In another example, a ratio of the thickness 218 to the thickness 216 may be in a range of 12:1 to 20:1. In some situations where the thickness 216 of the substance 208 is less than a few microns, such as on the order of tens of nanometers or hundreds of nanometers, the ratio between the thickness 218 of the liquid 210 and the thickness 216 of the substance 208 can be greater than 50:1, greater than 100:1, or greater than 250:1, or even greater.

Furthermore, the volume of the liquid 210 held in the apparatus 200 may change as the dimensions of the substrate 202 change. To illustrate, when the substrate 202 is a circular wafer having a diameter of 300 mm, the volume of the liquid 210 contained in the apparatus 200 can be in a range of 50 mL to 500 mL for certain operations described herein. In another illustration, when the substrate 202 is a circular wafer having a diameter of 200 mm, the volume of the liquid 210 can be in a range of 20 mL to 250 mL for certain operations described herein. In a further illustration, when the substrate 202 is a circular wafer having a diameter of 150 mm, the volume of the liquid 210 may be in a range of 10 mL to 50 mL for certain operations described herein.

In an embodiment, the apparatus 200 may include a raised rim such that when the substrate 202 is placed on the apparatus 200, the rim is above the substrate thereby forming a process bowl. According to an embodiment the apparatus 200 may have a predominately circular ring with at least two distinct planes connected by a vertical member. Upon the first plane, the substrate 202 can be placed and only the circumferential edge of the substrate 202 is contacted. Backside edges around notches or flats that might be present in the substrate 202 are considered edges and may also make contact with this plane. The perimeter edge of the substrate 202 may or may not contact the vertical member of the apparatus 200. The second plane may be flush with or extending beyond the topside of first side 204 of the substrate 202. The apparatus 200 may also include a means to hold the first and second planes in position that serves to connect the apparatus 200 to a device that has the ability to rotate the apparatus 200. The apparatus 200 may be designed such that the separation between the first and second planes is proportional to the volume of the liquid 208 that can be contained by the apparatus 200. The apparatus 200 can include a protrusion in the vertical member which can serve to rotationally constrain the substrate 200 so that the rotational velocity of the substrate 200 matches the rotational velocities described herein with respect to the process 100. Additionally, an an embodiment, the apparatus 200 can include a containment feature that aids in preventing liquids (e.g., stripping solution, rinsing agent, etc.) from leaving the first side 204 of the substrate 202 while the substrate is held in the process bowl and operations are performed on the substrate 200, such as the operations described previously with respect to the process 100.

In some embodiments, one or more of the operations described with respect to the process 100 may be performed while the substrate 202 is held in the apparatus 200, such that the process 100 is performed as a single-stage process. As used herein a “single stage process” refers to a process during which the substrate 202 remains in contact with a single substrate holder throughout the process. According to one embodiment, the holder may remain in a single cleaning chamber or “single bowl” throughout the process or it may rotate or move to one or more of a cleaning chamber, a rinsing chamber and a drying chamber. All unit operations (coating, heating, rinsing, drying, and other operations such as backside rinse) may be performed on the substrate 202 before the substrate 202 is removed from the process bowl. The substrate 202 may be processed such that once the substrate 202 is seated in the apparatus 200, all operations are performed until the total process is complete and then the substrate 202 is removed from the apparatus 200. Alternatively, the process may start once the substrate 202 is seated in the apparatus 200, and the substrate 202 may be unseated and reseated from the apparatus 200 for specific unit operations but remain in the single process module or single bowl until the total process is complete. In additional alternative embodiments, a first portion of the operations of the process 100 can be implemented in the apparatus 200, while a second portion of the operations of the process 100 can be implemented in one or more additional apparatuses. Thus, the process 100 can be a multi-stage process in some embodiments.

In some situations, after removing the substrate 202 from the apparatus 200, an additional substrate may be placed in the apparatus 200. In a particular embodiment, the additional substrate may undergo one or more of the operations that the substrate 202 is subjected to. In other embodiments, the additional substrate may undergo one or more operations that are different from those performed on the substrate 202. In various instances, the additional substrate can be contacted with one or more solutions that are different from those used to contact the substrate 202. Additionally, in a particular embodiment, a different substance may be removed from the additional substrate than the substance 208 removed from the substrate 202. In an embodiment, the additional substrate can be contacted with fresh volumes of the same solutions or substantially the same solutions used to contact the substrate 202. In this way, the effectiveness of the solutions used to contact each substrate provided to the apparatus 200 can be maximized because of minimal degradation and minimal contamination of the solutions.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLES

### Example 1

A 120 μm thick TOK 50120 dry film negative photoresist is disposed on a 300 mm wafer with Sn/Ag solder pillars. The composition of the stripping solution is 5 wt % tetramethylammonium hydroxide pentahydrate (pTMAH), 23.75 wt % dimethylaminoethanol (DMAE), and 71.25 wt % dimethylsulfoxide (DMSO). The wafer is processed on an EVG-301RS single wafer photoresist stripping equipment. The wafer is placed in a chuck where ˜96% of the surface area of the backside of the wafer is in contact with air, and the outer diameter of the chuck forms a liquid containment barrier around the perimeter of the wafer. The outer 3 mm radius of the backside of the wafer is in contact with the chuck. This chuck is referred to as the ring chuck. The wafer is covered with 220 mL of the stripping composition. The inner radius of the chuck is ˜4 mm larger than the outer radius of the wafer. The stripping composition fills the total inner diameter of the chuck, i.e., the stripping composition coats the entire top surface of the wafer and extends beyond the total diameter of the wafer to fill the total inner diameter of the chuck. Therefore, the thickness of the stripping composition on top of the wafer is approximately 2.95 mm. The ratio of the thickness of the stripping composition to the thickness of the resist is 25:1. The stripping composition is then heated by bringing a heater at 250° C. into close proximity (approximately 1 mm) of the liquid surface. In this manner, the liquid is heated by convective heating. During heating, the temperature is maintained by varying the separation distance between the heater and the liquid surface to control the liquid temperature to a target temperature. In this case, the target temperature for the stripping composition is 105° C. The total time in which heat is applied to the liquid is 7.5 min. After 7.5 min, the heater is removed. The wafer is then rinsed with deionized water via fan spray nozzles simultaneously while rotating at 500 rpm for 20 sec. The wafer is next rinsed with a small volume of IPA and finally dried by spinning the wafer at 1500 rpm for 20 sec. After this process, the photoresist is completely removed from the wafer.

### Example 2

A 120 μm thick TOK 50120 dry film negative photoresist is disposed on a 300 mm wafer with Sn/Ag solder pillars. The composition of the stripping composition is 5 wt % tetramethylammonium hydroxide pentahydrate (pTMAH), 23.75 wt % dimethylaminoethanol (DMAE), and 71.25 wt % dimethylsulfoxide (DMSO). The wafer is processed on an EVG-301RS single wafer photoresist stripping equipment. The wafer is placed in a chuck where approximately 96% of the surface area of the backside of the wafer is in contact with air, and the outer diameter of the chuck forms a liquid containment barrier around the perimeter of the wafer. The outer 3 mm radius of the backside of the wafer is in contact with the chuck. This chuck is referred to as the ring chuck. The wafer is covered with 70 mL of the stripping composition. The inner radius of the chuck is approximately 4 mm larger than the outer radius of the wafer. The stripping composition fills the total inner diameter of the chuck, i.e., the stripping composition coats the entire top surface of the wafer and extends beyond the total diameter of the wafer to fill the total inner diameter of the chuck. Therefore, the thickness of the stripping composition on top of the wafer is approximately 0.94 mm. The ratio of the thickness of the stripping composition to the thickness of the resist is 8:1. The stripping composition is then heated by bringing a heater at 250° C. into close proximity (˜1 mm) of the liquid surface. In this manner, the liquid is heated by convective heating. During heating, the temperature is maintained by varying the separation distance between the heater and the liquid surface to control the liquid temperature to a target temperature. In this case, the target temperature for the stripping composition is 105° C. The total time in which heat is applied to the liquid is 7.5 min. After 7.5 min, the heater is removed. The wafer is then rinsed with deionized water via fan spray nozzles simultaneously while rotating at 500 rpm for 20 sec. The wafer is next rinsed with a small volume of IPA and finally dried by spinning the wafer at 1500 rpm for 20 sec. After this process, most of the photoresist remained on the wafer and is not removed during the process.

### Example 3

A 50 μm thick TOK CR4000 positive spin-on photoresist is disposed on a 300 mm wafer with Cu pillars and Sn/Ag solder caps. The composition of the stripping composition is 58.6 wt % 1-formylpiperidine, 39.4 wt % aminoethylethanolamine, 1.5 wt % H₂O and 0.5% of a corrosion inhibitor, where the corrosion inhibitor is a mixture of dodecanedioic acid, undecanedioic acid, and sebacic acid, which may be sold under the trade name Corfree M1. The wafer is processed on an EVG-301RS single wafer photoresist stripping equipment. The wafer is placed in a chuck where approximately 96% of the surface area of the backside of the wafer is in contact with air, and the outer diameter of the chuck forms a liquid containment barrier around the perimeter of the wafer. The outer 3 mm radius of the backside of the wafer is in contact with the chuck. This chuck is referred to as the ring chuck. The wafer is covered with 70 mL of the stripping composition. During processing, the stripping composition remained only on the wafer and did not fill the full inner diameter of the chuck. Therefore, the thickness of the stripping composition on top of the wafer is approximately 1 mm. The ratio of the thickness of the stripping composition to the thickness of the resist is 20:1. The stripping composition is then heated by bringing a heater at 250° C. into close proximity (approximately 1 mm) of the liquid surface. In this manner, the liquid is heated by convective heating. During heating, the temperature is maintained by varying the separation distance between the heater and the liquid surface to control the liquid temperature to a target temperature. In this case, the target temperature for the stripping composition is 105° C. The total time in which heat is applied to the liquid is 4 min. After 4 min, the heater is removed. The wafer is then rinsed with deionized water via fan spray nozzles simultaneously while rotating at 500 rpm for 20 sec. The wafer is next rinsed with a small volume of IPA and finally dried by spinning the wafer at 1500 rpm for 20 sec. After this process, the photoresist is completely removed from the wafer.

### Example 4

A 80 μm thick Asahi CX8040 dry film negative photoresist is disposed on a 200 mm wafer with Sn/Ag solder pillars. The composition of the stripping composition is 5 wt % tetramethylammonium hydroxide pentahydrate (pTMAH), 23.75 wt % dimethylaminoethanol (DMAE), and 71.25 wt % dimethylsulfoxide (DMSO). The wafer is processed on an EVG-301RS single wafer photoresist stripping equipment. The wafer is placed in a pin chuck, where the wafer is supported on the backside only by pins, and the edges of the wafer are not contained. The wafer is covered with 50 mL of the stripping composition, and the stripping composition covered the complete top surface area of the 200 mm wafer. Therefore, the thickness of the stripping composition on top of the wafer is approximately 1.6 mm. The ratio of the thickness of the stripping composition to the thickness of the resist is 20:1. The stripping composition is then heated by bringing a heater at 250° C. into close proximity (approximately 1 mm) of the liquid surface. In this manner, the liquid is heated by convective heating. During heating, the temperature is maintained by varying the separation distance between the heater and the liquid surface to control the liquid temperature to a target temperature. In this case, the target temperature for the stripping composition is 110° C. The total time in which heat is applied to the liquid is 2 min and 20 sec. After 2 min and 20 sec, the heater is removed. The wafer is then rinsed with 25 mL of DMSO while spinning at 300 rpm. Then, the wafer is rinsed with deionized water via fan spray nozzles while rotating at 1000 rpm for 20 sec. The wafer is then rinsed with a small volume of IPA and finally dried by spinning the wafer at 2000 rpm for 25 sec. After this process, the photoresist is completely removed from the wafer.

### Example 5

A positive photoresist is disposed on a polyimide layer after etching a via through a polyimide layer. Vias are patterned in a positive photoresist then etched through the polyimide using an oxygen plasma. Wafers are processed on an EVG-301RS single wafer photoresist stripping equipment. To strip the remaining photoresist from the underlying polyimide, a single 150 mm wafer is coated with 16.5 mL of stripping composition, resulting in a thickness of 0.95 mm on top of the wafer. The composition of the stripping composition is 5.1 wt % tetramethylammonium hydroxide pentahydrate (pTMAH), 3 wt % monoethanolamine (MEA), 10 wt % 3-methoxy-3-methylbutanol, 81.9 wt % dimethylsulfoxide (DMSO), and 25 ppm EDTA. This stripping process is performed at room temperature. After dispense, the coated wafer sat at room temperature for 30 sec to dissolve the remaining resist. The wafer is then rinsed with 19.5 mL of DMSO while spinning at 300 rpm. After rinsing with DMSO, the wafer is slowed to 10 rpm to prevent the liquid on the wafer from becoming too thin and leading to dry spots on the wafer during the transition to the deionized (DI) water rinse step. Next, the wafer is rinsed for 20 sec with DI water, and then dried by spin drying. The total process time for one wafer is 1 min 55 sec with a total volume usage of stripping composition of 36 mL per wafer. After the process is completed, the resist is completely removed and the polyimide layer remained intact.

### Example 6

A post-etch residue is disposed on a GaAs substrate after etching features in the GaAs substrate using a plasma etch process. Wafers are processed on an EVG-301RS single wafer photoresist stripping equipment. To strip the post-etch residue from the wafer, a single 150 mm wafer is coated with 12 mL of stripping composition, resulting in a thickness of 0.7 mm on top of the wafer. The composition of the stripping composition is 5.1 wt % tetramethylammonium hydroxide pentahydrate (pTMAH), 3 wt % monoethanolamine (MEA), 10 wt % 3-methoxy-3-methylbutanol, 81.9 wt % dimethylsulfoxide (DMSO), and 25 ppm EDTA. After coating, the stripping composition is heated using proximity convective heating for a total of 30 sec, reaching a maximum temperature of 80° C. After heating, the wafer is then rinsed with 19.5 mL of DMSO while spinning at 300 rpm. After rinsing with DMSO, the wafer is slowed to 10 rpm to prevent the liquid on the wafer from becoming too thin and leading to dry spots on the wafer during the transition to the DI water rinse step. Next, the wafer is rinsed for 20 sec with DI water, and then dried by spin drying. The total process time for one wafer is 2 min 16 sec with a total volume usage of stripping composition of 31.5 mL per wafer. After the process is completed, the post-etch residue is completely removed from the wafer.

### Example 7

A post-etch residue is disposed on a silicon dioxide substrate after etching vias into the silicon dioxide wafer. Wafers are prepared using AZ 9260 where vias were plasma-etched into silicon dioxide. Wafers are processed on an EVG-301RS single wafer photoresist stripping equipment. To strip the post-etch residue, a 200 mm wafer is coated with 40 mL of stripping composition, resulting in a thickness of stripping composition of approximately 1.3 mm on top of the wafer. The composition of the stripping composition is 59.21% DMSO, 35.92% MEA, 4.85% pTMAH. The stripping composition is then heated by bringing a heater at 250° C. into close proximity (approximately 1 mm) of the liquid surface. In this manner, the liquid is heated by convective heating. During heating, the temperature is maintained by varying the separation distance between the heater and the liquid surface to control the liquid temperature to a target temperature. In this case, the target temperature for the stripping composition is 100° C. The total time in which heat is applied to the liquid is 4 min. After the prescribed time, the heater is removed. After heating, the wafer is rinsed with DI water via fan spray nozzles while rotating at 300 rpm for 20 sec. The water spray is turned on simultaneously with the wafer accelerating to 300 rpm at 500 rpm/sec. Finally, the wafer is dried by spin drying. After the process is completed, the post-etch residue is completely removed from the wafer.

### Example 8

A 120 μm thick Asahi CX A240 dry film negative photoresist is disposed on a 300 mm wafer with Sn/Ag solder pillars. Coupon-sized samples of the wafer are processed on a hot plate. Coupons are placed inside a holder with a well with a volume of 2.7 mL. 1.8 mL of formulation is used to cover the coupon, resulting in a thickness of formulation of approximately 2 mm on top of the coupon. The holder is placed on the hot plate such that the liquid temperature reached about 110° C. The samples are heated for different times depending on the formulation being tested. After heating, the coupon is then removed from the well using tweezers, is rinsed with pressurized water of 45 psi via a fan spray nozzle for 10-20 sec. Finally, the coupon is rinsed with IPA and blown dry with a stream of air. The formulation compositions, heating time, and resist removal results are summarized in the Table 1.

TABLE 1
Formulation compositions, heating time, and resist removal results
for Example 8.

| | Formulation Composition | Heating | Resist Removal |
|---|---|---|---|
| Example | (given in wt %) | Time (min) | Results |
| 8 | 24.75 wt % CHP, 9.95 | 5.5 | Complete resist |
| | wt % DMAE, 54.75 wt % | | removal |
| | MEA, 9.95 wt % MIPA, | | |
| | 0.6 wt % H₂O | | |

CHP = N-cyclohexyl-2-pyrrolidone
MEA = monoethanolamine
DMAE = dimethylaminoethanol
MIPA = 1-amino-2-propanol

### Examples 9 and 10

A 80 μm thick Asahi CX-8040 dry film negative photoresist is disposed on a 300 mm wafer with Pb/Sn alloy solder. Coupon-sized samples of the wafer are processed on a hot plate. Coupons are placed inside a holder with a well with a volume of 2.7 mL. 1.8 mL of formulation is used to cover the coupon, resulting in a thickness of formulation of approximately 2 mm on top of the coupon. The holder is placed on the hot plate such that the liquid temperature reached about 115° C. The samples are heated for different times depending on the formulation being tested. After heating, the coupon is then removed from the well using tweezers, is rinsed with pressurized water of 45 psi via a fan spray nozzle for 10-20 sec. Finally, the coupon is rinsed with IPA and blown dry with a stream of air. The formulation compositions, heating time, and resist removal results are summarized in the Table 2.

TABLE 2
Formulation compositions, heating time, and resist removal results
for Examples 9-10

| | Formulation Composition | Heating | Resist Removal |
|---|---|---|---|
| Example | (given in wt %) | Time (min) | Results |
| 9 | 85 wt % NMP, 3 wt % | 3 | Complete resist |
| | MEA, 9.3 wt % propylene | | removal |
| | glycol, 2.4 wt % TMAH, | | |
| | 0.3 wt % H₂O | | |
| 10 | 85 wt % NMP, 3 wt % | 3.5 | Complete resist |
| | DMAE, 9.3 wt % | | removal |
| | propylene glycol, 2.4 wt % | | |
| | TMAH, 0.3 wt % H₂O | | |

TMAH = tetramethylammonium hydroxide
NMP = n-methylpyrrolidone

### Example 11

A 80 μm thick Asahi CX-8040 dry film negative photoresist is disposed on a wafer with Sn/Ag alloy solder. Coupon-sized samples of the wafer are processed on a hot plate. Coupons are placed inside a holder with a well with a volume of 2.7 mL. 1.8 mL of formulation is used to cover the coupon, resulting in a thickness of formulation of approximately 2 mm on top of the coupon. The holder is placed on the hot plate such that the liquid temperature reached about 108° C. The sample is heated for 3.5 minutes. After heating, the coupon is then removed from the well using tweezers and rinsed with pressurized water of 45 psi via a fan spray nozzle for 10-20 sec. Finally, the coupon is rinsed with IPA and blown dry with a stream of air. The formulation compositions, heating time, and resist removal results are summarized in the Table 3.

TABLE 3
Formulation composition, heating time, and resist removal result for
Example 11.

| | Formulation Composition | Heating | Resist Removal |
|---|---|---|---|
| Example | (given in wt %) | Time (min) | Results |
| 11 | 77 wt % NMP, 3 wt % | 3.5 | Complete resist |
| | MEA, 15.5 wt % propylene | | removal |
| | glycol, 4 wt % DMDPAH, | | |
| | 0.5 wt % H₂O | | |

DMDPAH = dimethyldipropylammonium hydroxide

What is claimed is:

1. A process, comprising:
providing a substrate including a first side and a second side substantially parallel to the first side, wherein a substance is disposed on at least a portion of the first side of the substrate;
contacting the substance with a solution such that the first side of the substrate is coated with the solution to a thickness and at least a portion of the second side of the substrate is free from the solution, wherein the solution includes an organic base and less than 1000 parts per million (ppm) of a sulfonated polymer, a sulfonated monomer, or both; and
rinsing the first side of the substrate with a volume of a rinsing agent sufficient to remove a volume of the solution on the first side of the substrate and the at least a portion of the substance released from the first side of the substrate.

2. The process of claim 1, wherein the at least a portion of the substance is released from the substrate without agitation.

3. The process of claim 1, wherein the solution includes a polar solvent.

4. The process of claim 1, wherein the solution is free of the sulfonated polymer, the sulfonated monomer, or both.

5. The process of claim 1, wherein the solution is free of an inorganic base.

6. The process of claim 1, wherein the solution includes 0.5 wt % to 99 wt % of the organic base for a total weight of the solution.

7. The process of claim 1, wherein the substance includes negative photoresist exposed to actinic radiation.

8. The process of claim 1, wherein the substance includes positive photoresist.

9. The process of claim 1, wherein a ratio of the thickness of the solution to a thickness of the substance on at least a portion of the substrate is greater than 6:1.

10. The process of claim 1, further comprising forming features on a surface of the substrate with a plasma etch process, wherein a residue is formed on the substrate in response to the plasma etch process, and the substance includes the residue.

11. The process of claim 1, wherein the thickness of the substance on the first side of the substrate is in a range of 0.2 micrometers to 150 micrometers.

12. The process of claim 1, wherein the substrate has a diameter in a range of 50 mm to 450 mm.

13. The process of claim 1, wherein a temperature of the solution is in a range of 20° C. to 150° C.

14. The process of claim 1, wherein contacting the substance with the solution includes dispensing the solution into a process bowl holding the substrate, and the process further comprises heating the solution, the substrate, or both to a temperature and for a time sufficient to release at least a portion of the substance from the first side of the substrate; wherein the solution, the substrate, or both are heated for a duration in a range of 20 seconds to 20 minutes after dispensing the solution into the process bowl.

15. A process comprising:
providing a substrate including a first side and a second side substantially parallel to the first side, wherein a substance is disposed on at least a portion of the first side of the substrate to a first thickness;
contacting the substance with a solution such that the first side of the substrate is coated with the solution to a second thickness, at least a portion of the second side of the substrate is free from the solution and at least a portion of the substance is released from the first side of the substrate, wherein the second thickness is greater than 1 mm and a ratio of the second thickness to the first thickness is greater than 6:1; and
rinsing the first side of the substrate with a volume of a rinsing agent sufficient to remove a volume of the solution on the first side of the substrate and the at least a portion of the substance released from the first side of the substrate.

16. The process of claim 15, wherein the solution, the substrate, or both are not agitated during the contacting the substance with the solution.

17. The process of claim 15, wherein greater than 90% of the second side of the substrate is free from the solution.

18. The process of claim 15, wherein substantially all of the substance is removed from the substrate.

19. The process of claim 15, wherein at least 95% of the substance is removed from the substrate.

20. The process of claim 15, wherein the ratio of the second thickness to the first thickness is in a range of 8:1 to 1000:1.

21. The process of claim 15, further comprising heating the solution, the substrate, or both after contacting the substance with the solution.

22. The process of claim 15, wherein the solution includes an organic base, a polar solvent, or both.

23. A process, comprising:
placing a substrate in an apparatus including a process bowl, such that the substrate is held within the process bowl, the substrate including a first side and a second side substantially parallel to the first side and a substance is disposed on at least a portion of the first side of the substrate;
contacting the substance with a solution by dispensing the solution into the process bowl after placing the substrate in the apparatus such that the first side of the substrate is coated with the solution and at least a portion of the second side of the substrate is free from the solution;
heating the solution, the substrate, or both after dispensing the solution into the process bowl for a duration in a range of 20 seconds to 20 minutes such that at least a portion of the substance is released from the first side of the substrate; and
rinsing the substrate with a volume of a rinsing agent sufficient to remove a volume of the solution on the substrate and the at least a portion of the substance released from the first side of the substrate.

24. The process of claim 23, wherein the solution, the substrate, or both are heated from a starting temperature to a target temperature and a difference between the starting temperature and the target temperature is at least 20° C.

25. The process of claim 23, wherein the solution, the substrate, or both are not agitated during the heating of the solution.

26. The process of claim 23, wherein the solution, the substrate, or both are not agitated during the rinsing of the substrate.

27. The process of claim 23, wherein the apparatus includes a containment feature to keep the solution, the rinsing agent or both on the first side of the substrate.

28. The process of claim 23, wherein the process bowl holds a single substrate.

29. The process of claim 23, wherein the heating the solution, the substrate, or both includes placing a heat source within a specified distance from the solution, the substrate, or both until a target temperature of the solution, the substrate, or both is achieved.

30. The process of claim 29, wherein a temperature of the heat source is 50° C. to 200° C. greater than the target temperature.

31. The process of claim 23, wherein the solution is drained from the process bowl before rinsing the first side of the substrate.

32. The process of claim 31, further comprising removing the substrate from the apparatus after rinsing the substrate.

33. The process of claim 32, wherein the substrate is a first substrate, the substance disposed on at least a portion of the substrate is a first substance, the solution is a first solution, and the process further comprising:
placing a second substrate in the apparatus after removing the first substrate from the apparatus, the second substrate including a first side and a second side substantially parallel to the first side, wherein a second substance is disposed on at least a portion of the first side of the second substrate to a first thickness; and
dispensing a fresh volume of a second solution into the process bowl such that the first side of the second substrate is coated with the second solution to a second thickness, at least a portion of the second side of the second substrate is free from the second solution and at least a portion of the second substance is released from the first side of the second substrate.

34. The process of claim 33, wherein:
the second solution is substantially the same as the first solution; and
the second substance is substantially the same as the first substance.

35. The process of claim 34, wherein the second solution is different from the first solution and the second substance is different from the first substance.

36. The process of claim 33, wherein the first substrate is coated with the first solution to a first thickness and the second substrate is coated with the second solution to a second thickness.

37. The process of claim 36, wherein the first thickness is different from the second thickness.

38. A process, comprising:
providing a substrate including a first side and a second side substantially parallel to the first side, wherein a substance is disposed on at least a portion of the first side of the substrate;
contacting the substance with a solution such that the first side of the substrate is coated with the solution to a thickness and at least a portion of the second side of the substrate is free from the solution, wherein the solution includes a polar solvent and less than 1000 parts per million (ppm) of a sulfonated polymer, a sulfonated monomer, or both;
heating the solution, the substrate, or both after contacting the substrate with the solution to a temperature and for a time sufficient to release at least a portion of the substance from the first side of the substrate; and
rinsing the first side of the substrate with a volume of a rinsing agent sufficient to remove the solution and the at least a portion of the substance released from the first side of the substrate.

39. The process of claim 38, wherein the polar solvent is a polar aprotic solvent.

40. The process of claim 38, wherein the solution includes 10 wt % to 99 wt % polar solvent for a total weight of the solution.

41. The process of claim 38, wherein the solution is free of the sulfonated polymer or a sulfonated monomer.

42. The process of claim 38, wherein the solution is free of the inorganic base.

43. The process of claim 38, wherein a ratio of the thickness of solution to a thickness of the substance on at least a portion of the substrate is greater than 6:1.
